(19) United States
(12) Patent Application Publication
(10) Pub. No.: US 2026/0222804 A1
(43) Pub. Date: Jul. 30, 2026

(54) METHOD FOR OBTAINING KEY, DEVICE, AND STORAGE MEDIUM

(71) Applicant: BEIJING XIAOMI MOBILE SOFTWARE CO., LTD., Beijing (CN)

(72) Inventors: Haoran LIANG, Beijing (CN); Wei LU, Beijing (CN); Jianning LIU, Beijing (CN)

(21) Appl. No.: 19/145,747

(22) PCT Filed: Jan. 6, 2023
(86) PCT No.: PCT/CN2023/070913

§ 371 Date: Jul. 3, 2025

(51) Int. Cl. H04W 12/0431; H04W 12/041; H04W 12/06; H04W 48/16

(52) U.S. Cl. CPC H04W 12/0431; H04W 12/041; H04W 12/06; H04W 48/16

(57) ABSTRACT

A method for obtaining a key, performed by an application function (AF), where the method includes: receiving a first request message sent by a terminal device, where the first request message includes key identifier information; and determining an identifier of a visited network, related to the AF, of the terminal device, where the identifier of the visited network is configured for a first network device in the visited network to obtain a key corresponding to the key identifier information.

### CROSS-REFERENCE TO RELATED APPLICATION

The present application is a U.S. National Stage of International Application No. PCT/CN2023/070913, filed on Jan. 6, 2023, the contents of all of which are incorporated herein by reference in their entireties for all purposes.

### BACKGROUND OF THE INVENTION

Identity authentication and key management for applications in a terminal device can be achieved based on authentication and key management for application (AKMA) defined by the 3rd generation partnership project (3GPP). In some scenarios, an AKMA mechanism has been used as a solution to protect the communication between the terminal device and an application function (AF).

### SUMMARY OF THE INVENTION

The present disclosure relates to the technical field of communications, in particular to a method for obtaining a key, a device and a storage medium.

In a first aspect, an embodiment of the present disclosure provides a method for obtaining a key, performed by an application function (AF). The method includes: receiving a first request message sent by a terminal device, where the first request message includes: key identifier information; and determining an identifier of a visited network, related to the AF, of the terminal device, where the identifier of the visited network is configured for a first network device in the visited network to obtain a key corresponding to the key identifier information.

In a second aspect, an embodiment of the present disclosure provides a method for obtaining a key, performed by a second network device in a home network of a terminal device. The method includes: determining an application key corresponding to key identifier information, where the application key is provided to a first network device in a visited network based on an identifier of the visited network, related to an application function (AF), of the terminal device.

In a third aspect, an embodiment of the present disclosure provides a method for obtaining a key, performed by a first network device in a visited network of a terminal device, where the visited network is related to an application function (AF). The method includes: obtaining a key corresponding to key identifier information, where the key is provided to the first network device based on an identifier of the visited network.

In a fourth aspect, an embodiment of the present disclosure provides a communication device. The communication device includes one or more processors and a memory, where the memory stores a computer program, and the one or more processors are collectively configured to execute the computer program stored in the memory, to cause the communication device to perform the above-mentioned method for obtaining the key.

In a fifth aspect, an embodiment of the present disclosure provides non-transitory a computer-readable storage medium storing instructions used by the above-mentioned application function (AF); where the instructions, when executed, cause the application function (AF) to perform the above-mentioned method for obtaining the key described in the first aspect.

### BRIEF DESCRIPTION OF DRAWINGS

In order to more clearly illustrate the technical solutions in the embodiments of the present disclosure or in the background art, the accompanying drawings needed to be used in the embodiments or the background art of the present disclosure are described below.

FIG. 1 is a schematic architecture diagram of a communication system provided by an embodiment of the present disclosure;

FIG. 2 is a schematic flowchart of a method for obtaining a key provided by an embodiment of the present disclosure;

FIG. 3 is a schematic flowchart of a method for obtaining a key provided by an embodiment of the present disclosure;

FIG. 4 is a schematic flowchart of another method for obtaining a key provided by an embodiment of the present disclosure;

FIG. 5a is a schematic flowchart of another method for obtaining a key provided by an embodiment of the present disclosure;

FIG. 5b is a schematic flowchart of another method for obtaining a key provided by an embodiment of the present disclosure;

FIG. 6 is a schematic flowchart of another method for obtaining a key provided by an embodiment of the present disclosure;

FIG. 7a is a schematic flowchart of another method for obtaining a key provided by an embodiment of the present disclosure;

FIG. 7b is a schematic flowchart of another method for obtaining a key provided by an embodiment of the present disclosure;

FIG. 7c is a schematic flowchart of another method for obtaining a key provided by an embodiment of the present disclosure;

FIG. 8 is a schematic flowchart of another method for obtaining a key provided by an embodiment of the present disclosure;

FIG. 9 is a schematic flowchart of another method for obtaining a key provided by an embodiment of the present disclosure;

FIG. 10 is a schematic flowchart of yet another method for obtaining a key provided by an embodiment of the present disclosure;

FIG. 11 is a schematic flowchart of yet another method for obtaining a key provided by an embodiment of the present disclosure;

FIG. 12 is a schematic flowchart of yet another method for obtaining a key provided by an embodiment of the present disclosure;

FIG. 13 is a schematic structural diagram of a communication device provided by an embodiment of the present disclosure;

FIG. 14 is a schematic structural diagram of another communication device provided by an embodiment of the present disclosure; and

FIG. 15 is a schematic structural diagram of a chip provided by an embodiment of the present disclosure.

### DETAILED DESCRIPTION OF THE INVENTION

The embodiments are described in detail below, with examples illustrated in the accompanying drawings. In the following description involving the accompanying drawings, unless otherwise indicated, the same reference numbers across different accompanying drawings refer to the same or similar elements. The implementations described in the following embodiments are not all the implementations consistent with the embodiments of the present disclosure. Instead, these embodiments are merely examples of devices and methods consistent with some aspects of the embodiments of the present disclosure, as detailed in the appended claims.

The terms used in the embodiments of the present disclosure are merely for the purpose of describing particular embodiments and are not intended to limit the embodiments of the present disclosure. The singular forms “a/an” and “the” used in the embodiments and the appended claims of the present disclosure are also intended to include the plural forms, unless the context clearly indicated otherwise. It is also to be understood that the term “and/or” as used here refer to and includes any or all possible combinations of one or more related listed items.

It is to be understood that, although the terms “first,” “second,” “third,” etc. may be used to describe various information in the embodiments of the present disclosure, such information could not be limited by these terms. These terms are merely used to distinguish information of the same type from each other. For example, information referred to as “first” may be referred to as “second” without departing from the scope of the embodiments of the present disclosure. Similarly, information referred to as “second” may be referred to as “first”. Depending on the context, the words “if” and “when” as used here may be interpreted as “in a case where . . . ” or “upon . . . ” or “in response to determining”.

For ease of understanding, the terms involved in the present disclosure are first introduced.
1. Access and mobility management function (AMF).

AMF is a logical node function network element on a core network side. The logical node function network element, serving as an access point between a terminal and a wireless core network control plane, receives all connection-related information and session-related information from user equipment, and performs registration, connection, reachability, and mobility management. In addition, the AMF provides a message transmission channel for session management between a terminal device and a session management function (SMF) device, and provides identification and authentication functions during user access.
2. Application function (AF), similar to an application server, may interact with other network functions (NFs) of the core network control plane and provide business services. AF may exist for different types of application services and may be owned by an operator or a trusted third party.
3. Network exposure function (NEF), located between a core network and an external third-party application function body (possibly also including some internal AFs), is responsible for managing all external applications whose network data is open. NEF provides corresponding security assurance to ensure the access security of the external applications to a 3GPP network, and provides open of quality of service (QoS) customization capability, mobility status event subscription, AF request distribution and other functions for the external applications.
4. User plane function (UPF), including routing and forwarding of user data packets, data interaction with external data networks, quality of service (QoS) processing for a user plane, implementation of flow control rules (e.g., gating, redirection, and traffic steering), etc.
5. Authentication server function (AUSF), configured to receive an authentication request for user equipment (UE) from AMF, request a key from a unified data management (UDM), and then forward the key issued by UDM to AMF for authentication processing.
6. Unified data management (UDM).

UDM is responsible for the management of terminal device identifiers, subscription data and authentication data, and the registration management of service network elements of terminal devices (such as AMF currently serving the terminal device, for example, UDM may initiate a logout message to the previous AMF, requesting the previous AMF to delete user-related information in a case where the terminal device switches to a different AMF for access).
7. AKMA anchor function (AAnF), a newly introduced network element in AKMA. AAnF may perform two-way authentication with UE using an authentication and key agreement (AKA) protocol to generate a shared key upon successful authentication. AAnF may transmit the shared key, related key parameters, user data and the like to a network AF. The shared key may be used for the secure transmission of information between UE and AF.
8. Policy control function (PCF), supporting a unified policy framework to manage network behaviors, providing policy rules for network entities to implement and execute, and accessing subscription information from a unified data warehouse.

Embodiments of the present disclosure provide a method and device for obtaining a key, a device, a chip system, a storage medium, a computer program and a computer program product, which may be applied to the technical field of communications and enable an AKMA mechanism to effectively support a multiple registrations scenario.

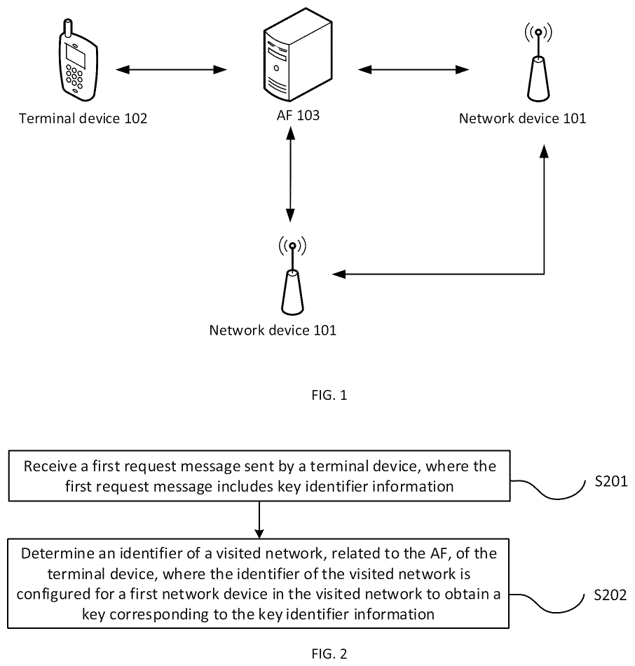

Referring to FIG. 1, FIG. 1 is a schematic architecture diagram of a communication system provided by an embodiment of the present disclosure. The communication system may include, but is not limited to, one network device, one terminal device, and an application function (AF). The number and forms of devices shown in FIG. 1 are provided for illustrative purposes merely and do not constitute a limitation on the embodiments of the present disclosure. In practical applications, the system may include two or more network devices and two or more terminal devices. As an example, the communication system shown in FIG. 1 includes two network devices 101, one terminal device 102, and an application function (AF) 103.

It is to be noted that the technical solutions in the embodiments of the present disclosure may be applied to various communication systems, such as a long term evolution (LTE) system, a 5th generation (5G) mobile communication system, a 5G new radio (NR) system or other future novel mobile communication systems.

The network device 101 in the embodiment of the present disclosure refers to a network-side entity configured to transmit or receive signals. For example, the network device 101 may be an evolved NodeB (eNB), a transmission reception point (TRP), a next-generation NodeB (gNB) in an NR system, a base station in other future mobile communication systems, or an access node in a wireless fidelity (Wi-Fi) system. The embodiments of the present disclosure do not pose any limitations on the specific technologies and physical forms adopted by the network device.

The network device provided in the embodiment of the present disclosure may include a central unit (CU) and a distributed unit (DU). The CU may be referred to as a control unit. The adoption of a CU-DU structure may decouple protocol layers of the network device such as a base station, where the functions of some protocol layers are centrally controlled by the CU, the functions of remaining part or all of the protocol layers are distributed in the DU, and the CU performs centralized control over the DU.

The terminal device 102 in the embodiment of the present disclosure refers to a user-side entity configured to receive or transmit signals, such as a mobile phone. The terminal device may be referred to as a terminal, user equipment (UE), a mobile station (MS), a mobile terminal (MT), etc. The terminal device may be a vehicle with a communication function, a smart car, a mobile phone, a wearable device, a tablet computer (Pad), a computer with a wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc.

The embodiments of the present disclosure do not pose any limitations on specific technologies and physical forms adopted by the terminal device.

It may be understood that the communication system described in the embodiments of the present disclosure is intended to more clearly illustrate the technical solutions in the embodiments of the present disclosure, and do not constitute a limitation on the technical solutions provided by the embodiments of the present disclosure. A person of ordinary skill in the art may know that with the evolution of system architectures and the emergence of new business scenarios, the technical solutions provided by the embodiments of the present disclosure are also applicable to similar technical problems.

One network device 101 may be a network device in a home network of the terminal device, and the other network device may be a network device in a visited network of the terminal device. In the following description, the network device in the visited network of the terminal device may be referred to as a first network device, while the network device in the home network of the terminal device may be referred to as a second network device, which are not limited here.

The method and device for obtaining the key provided by the present disclosure are introduced in detail below in conjunction with the accompanying drawings. FIG. 2 is a schematic flowchart of a method for obtaining a key provided by an embodiment of the present disclosure, where the method is performed by an application function (AF). The method for obtaining the key in the present embodiment may be applied to the application function (AF), which is not limited here.

As shown in FIG. 2, the method may include, but is limited to, the following steps.

S201: a first request message sent by a terminal device is received, where the first request message includes key identifier information.

The terminal device may support an AKMA service. During AKMA authentication for the terminal device, the terminal device and the authentication service function (AUSF) generate an authentication and key management root key (kakma) and AKMA key identifier (A-KID) for an application respectively, after the terminal device has successfully registered and completed primary authentication. The terminal device then requests a session service from the application function (AF), and the AF requests kakma from AUSF using the key identifier information sent by the terminal device. The AUSF determines a key management root key (kakma) based on the key identifier information, and sends the key management root key (kakma) to an AAnF. The key management root key (kakma) may be configured to determine an application key. Subsequently, the AF may obtain the application key and its validity period from the AAnF.

In the embodiment of the present disclosure, the first request message may be a reused application session establishment request message from related technologies, or a new application session establishment request message, which is not limited here.

The first request message may be used to request the establishment of an application session between the AF and UE. The first request message may include key identifier information (A-KID). The key identifier information may be configured to uniquely identify a key needed to establish the application session between the AF and the UE.

In the embodiment of the present disclosure, a key may, for example, be a key derived from the key management root key (kakma) based on authentication and key management for application (AKMA). The key may include an application key and an encryption key.

S202: an identifier of a visited network, related to the AF, of the terminal device is determined, where the identifier of the visited network is configured for a first network device in the visited network to obtain a key corresponding to the key identifier information.

In related technologies, a network device (e.g., an AKMA anchor function (AAnF) network element) in a home network of a terminal device and an AF send keys to a visited network of a terminal device in order to support roaming. In a multiple registrations scenario, the terminal device may be connected to a plurality of visited networks at the same time. However, since the terminal device establishes connection with the AF merely using one specific visited network to establish a connection with the AF, distributing the keys to the network devices of the plurality of visited networks could result in the AKMA mechanism being unable to effectively support the multiple registrations scenario.

In the embodiment of the present disclosure, the AF may determine the identifier of the visited network, related to the AF, of the terminal device after receiving the first request message sent by the terminal device, and then, enable the first network device of the visited network to obtain a key corresponding to the key identifier information based on the identifier of the visited network.

The identifier of the visited network may be configured to identify a visited network related to the AF. The identifier of the visited network may, for example, be a network identifier. The identifier of the visited network, related to the AF, of the terminal device may specifically refer to an identifier of a visited network, which is involved in at least one of the establishment of a connection, a session, business, or an AF session between the terminal device and the AF, or refer to an identifier of a visited network, which is involved in the establishment of a protocol data unit (PDU) session between the terminal device and at least one of UPF or PCF connected to the AF, which is not limited here.

The visited network related to the AF may refer to a visited network, which is involved in the establishment of at least one of a connection, a session, business, or an AF session between the terminal device and the AF, or refer to a visited network, which is involved in the establishment of a protocol data unit (PDU) session between the terminal device and at least one of UPF or PCF connected to the AF.

In other words, the terminal device may be connected to a plurality of visited networks at the same time in a multiple registrations scenario of the terminal device. The embodiment of the present disclosure supports the identification of the identifier of the visited network, related to the AF, from the plurality of visited networks. This enables the key corresponding to the key identifier information to be provided merely to the first network device in the visited network related to the AF, without triggering the provision of the key corresponding to the key identifier information to network devices in other visited networks unrelated to the AF, enabling the AKMA mechanism to effectively support the multiple registrations scenario.

According to the method for obtaining the key provided by the embodiment of the present disclosure, the first network device includes at least one of a UPF network element, a second AAnF network element, or an access and mobility management function (AMF) network element, which is not limited here.

The second AAnF network element refers to an AAnF network element of the visited network, related to the AF, of the terminal device. Correspondingly, the following first AAnF network element refers to an AAnF network element in a home network of the terminal device.

In the present embodiment, the AF receives the first request message sent by the terminal device, where the first request message includes: the key identifier information; and determines the identifier of the visited network, related to the AF, of the terminal device, where the identifier of the visited network is configured for the first network device in the visited network to obtain the key corresponding to the key identifier information. This enables the key corresponding to the key identifier information to be provided merely to the first network device in the visited network related to the AF, without triggering the provision of the key corresponding to key identifier information to network devices in other visited networks unrelated to the AF, enabling the AKMA mechanism to effectively support the multiple registrations scenario.

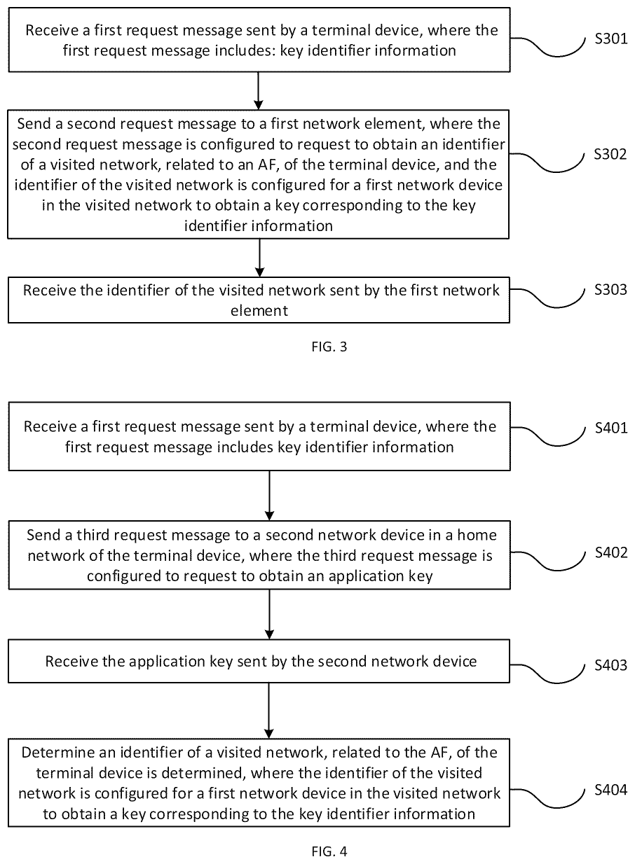

FIG. 3 is a schematic flowchart of a method for obtaining a key provided by an embodiment of the present disclosure. The method is performed by an application function (AF). The method for obtaining the key in the present embodiment may be applied to the application function (AF), which is not limited here.

As shown in FIG. 3, the method may include, but is limited to, the following steps.
S301: a first request message sent by a terminal device is received, where the first request message includes: key identifier information.
S302: a second request message is sent to a first network element, where the second request message is configured to request to obtain an identifier of a visited network, related to an AF, of the terminal device, and the identifier of the visited network is configured for a first network device in the visited network to obtain a key corresponding to the key identifier information.

According to the method for obtaining the key provided by the embodiment of the present disclosure, the first network element may be at least one of a user plane function (UPF) network element or a policy control function (PCF) network element.

The first network element may be a UPF network element connected to the AF, or a PCF network element connected to the AF, or the UPF network element and the PCF network element that are connected to the AF, which is not limited here.

The second request message is configured to request to obtain the identifier of the visited network, related to the AF, of the terminal device. The AF may send the second request message to at least one of the user plane function (UPF) network element or the policy control function (PCF) network element, so as to request to obtain the identifier of the visited network from at least one of the user plane function (UPF) network element or the policy control function (PCF) network element.
S303: the identifier of the visited network sent by the first network element is received.

In the present embodiment, the first request message sent by the terminal device is received, where the first request message includes: the key identifier information. The second request message is sent to the first network element, where the second request message is configured to request to obtain the identifier of the visited network, related to the AF, of the terminal device, and the identifier of the visited network is configured for the first network device in the visited network to obtain the key corresponding to the key identifier information. And the identifier of the visited network sent by the first network element is received. This enables the identifier of the visited network, related to the AF, of the terminal device to be obtained promptly, enabling the AKMA mechanism to effectively support the multiple registrations scenario.

According to the method for obtaining the key provided by the embodiment of the present disclosure, in the step of determining the identifier of the visited network, related to the AF, of the terminal device, the identifier of the visited network, related to the AF, may be obtained from a local policy of the AF, where the local policy of the AF is a local policy associated with the first network element involved in establishing service connections with terminal device. This enables the identifier of the visited network, related to the AF, of the terminal device to be obtained flexibly, enabling the AKMA mechanism to effectively support the multiple registrations scenario.

The first network element may be a UPF network element connected to the AF, or a PCF network element connected to the AF, or the UPF network element and the PCF network element that are connected to the AF, which is not limited here.

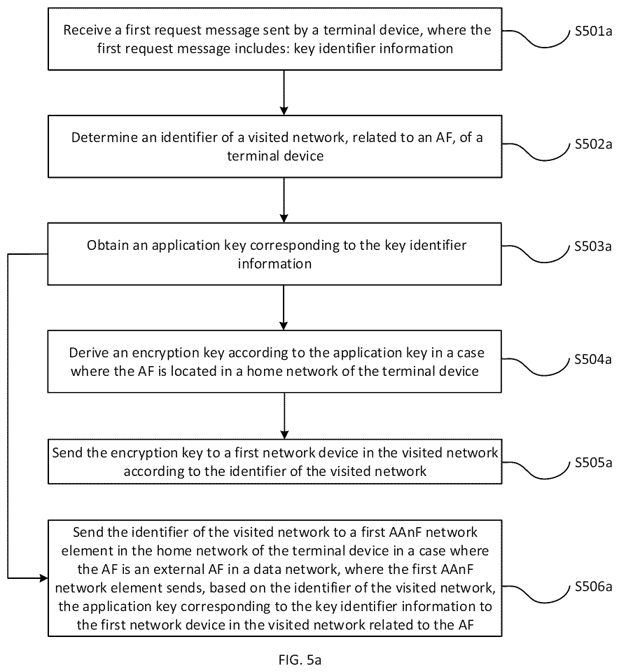

FIG. 4 is a schematic flowchart of another method for obtaining a key provided by an embodiment of the present disclosure. The method is performed by an application function (AF). The method for obtaining the key in the present embodiment may be applied to the application function (AF), which is not limited here.

As shown in FIG. 4, the method may include, but is limited to, the following steps.
S401: a first request message sent by a terminal device is received, where the first request message includes key identifier information.
S402: a third request message is sent to a second network device in a home network of the terminal device, where the third request message is configured to request to obtain an application key.

The network device of the home network of the terminal device may be referred to as a second network device.

In the embodiment of the present disclosure, after receiving the first request message sent by the terminal device and determining the key identifier information based on the first request message, the AF may request interaction with the second network device of the home network of the terminal device, so as to request to obtain an application key corresponding to the key identifier information from the second network device. For example, the AF may send a third request message to the second network device of the home network of the terminal device. The second network device of the home network of the terminal device determines, based on the third request message, the application key corresponding to the key identifier information. And then, the second network device sends a response message for the third request message to the AF. The response message may contain the requested application key corresponding to the key identifier information.
S403: the application key sent by the second network device is received.

The AF may receive the application key sent by the second network device, trigger, based on the application key corresponding to the key identifier information, the establishment of a connection with UE, and then determine the identifier of the visited network, related to the AF, of the terminal device. This enables the first network device in the visited network, related to the AF, to obtain the application key corresponding to the key identifier information.

According to the method for obtaining the key in the embodiment of the present disclosure, the second network device includes a first AAnF network element. The third request message is sent to a first AAnF network element and the application key sent by the first AAnF network element is received, in a case where the AF is located in the home network.

The AF located in the home network may refer to an internal HPLMN AF located in the home network. HPLMN stands for a home public land mobile network.

According to the method for obtaining the key in the embodiment of the present disclosure, the second network device includes a network exposure function (NEF) network element and a first AAnF network element. The third request message is sent to the NEF network element in a case where the AF is an external AF in a data network, and the third request message is configured to request the NEF network element to obtain the application key from the first AAnF network element and to receive the application key sent by the NEF network element.

The AF being the external AF in the data network refers to the external AF in the data network.

In other words, the embodiments of the present disclosure provide two methods for obtaining the application key. A way for obtaining the application key may be determined according to the location of the AF. The application key is obtained from the first AAnF network element in the home network in a case where the AF is located in the home network. The application key is obtained from the first AAnF network element by using the NEF network element in the home network in a case where the AF is the external AF in the data network. This enhances the flexibility in obtaining the application key, and increases the probability of successful obtaining the application key.

In the embodiment of the present disclosure, in a case where the key identifier information (A-KID) contains information of the home network of the terminal equipment UE, the AF may determine the location of the AF according to the information of the home network of the terminal equipment UE, and select the way for obtaining the application key according to the location of the AF, so as to obtain the application key.
S404: an identifier of a visited network, related to the AF, of the terminal device is determined, where the identifier of the visited network is configured for a first network device in the visited network to obtain a key corresponding to the key identifier information.

It is to be noted that the steps of the method for obtaining the key in the present embodiment may be performed at the same time or in any order, which is not limited in the embodiment of the present disclosure.

In the present embodiment, the first request message sent by the terminal device is received, where the first request message includes: the key identifier information. The third request message is sent to the second network device in the home network of the terminal device, where the third request message is configured to request to obtain the application key. The application key sent by the second network device is received. And the identifier of the visited network, related to the AF, of the terminal device is determined, where the identifier of the visited network is configured for the first network device in the visited network to obtain the key corresponding to the key identifier information. This enables the AKMA mechanism to effectively support the multiple registrations scenario and allows for timely establishment of the application session connection between the AF and the UE, effectively improving the efficiency of application session establishment in the multiple registrations scenario.

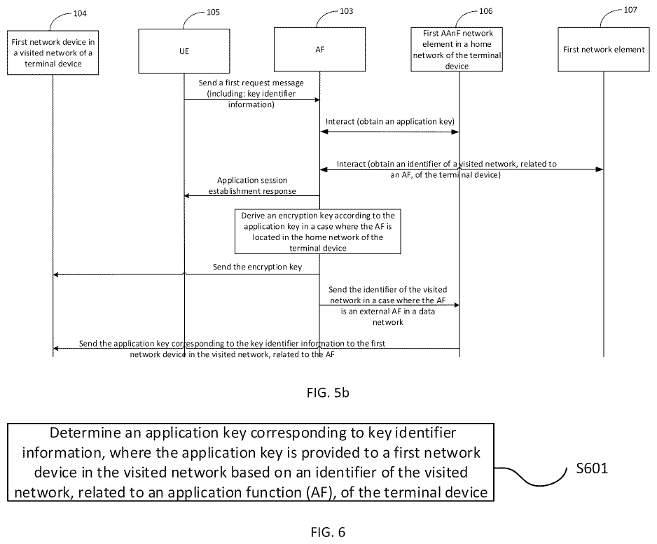

FIG. 5a is a schematic flowchart of another method for obtaining a key provided by an embodiment of the present disclosure. The method is performed by an application function (AF). The method for obtaining the key in the present embodiment may be applied to the application function (AF), which is not limited here.

As shown in FIG. 5a, the method may include, but is not limited to, the following steps.
S501a: a first request message sent by a terminal device is received, where the first request message includes: key identifier information.
S502a: an identifier of a visited network, related to an AF, of a terminal device is determined.
S503a: an application key corresponding to the key identifier information is obtained.
S504a: an encryption key is derived according to the application key in a case where the AF is located in a home network of the terminal device.
S505a: the encryption key is sent to a first network device in the visited network according to the identifier of the visited network.
S506a: the identifier of the visited network is sent to a first AAnF network element in the home network of the terminal device in a case where the AF is an external AF in a data network, where the first AAnF network element sends, based on the identifier of the visited network, the application key corresponding to the key identifier information to the first network device in the visited network related to the AF.

In other words, the AF sends the encryption key corresponding to the key identifier information to the first network device in a case where the AF is located in the home network of the terminal device. The AF sends the identifier of the visited network to the first AAnF network element in the home network of the terminal device in a case where the AF is the external AF in the data network, and the first AAnF network element sends the application key corresponding to the key identifier information to the first network device, where the encryption key corresponding to the key identifier information and the application key corresponding to the key identifier information both belong to the key corresponding to the key identifier information.

A timing diagram for the present embodiment may be shown in FIG. 5b. FIG. 5b is a schematic flowchart of another method for obtaining a key provided by an embodiment of the present disclosure. FIG. 5b shows a schematic diagram of interactions among an AF 103, a terminal device (for example, a user equipment (UE) 105), a first network device 104, a first AAnF network element 106 in a second network device, and a first network element 107. The home network of the terminal device may be represented as a home network. The visited network of the terminal device may be represented as a visited network. The first AAnF network element in the second network device may be represented as hAAnF. The second AAnF network element in the first network device may be represented as vAAnF. An application session establishment response may be generated in a case where the AF successfully obtains the application key. An application session establishment may be refused, with a reason for the failure, in a case where the AF fails to obtain the application key. Subsequently, UE may trigger a new application session establishment request to the AF of AKMA using the latest A-KID.

It is to be noted that the steps of the method for obtaining the key in the present embodiment may be performed at the same time or in any order, which is not limited in the embodiment of the present disclosure.

In other words, in the present embodiment, a way for sending the key to the first network device in the visited network related to the AF, is determined according to the location of the AF. The AF sends an encryption key to the first network device in the visited network related to the AF, in a case where the AF is located in the home network of the terminal device, where the encryption key is derived from the application key. The AF provides the identifier of the visited network to the first AAnF network element of the home network of the terminal device and the first AAnF network element sends the application key to the first network device in the visited network related to the AF, in a case where the AF is an external AF in a data network. This improves the flexibility in sending the key (at least one of the encryption key or the application key), enabling the first network device in the visited network related to the AF to effectively obtain the key corresponding to the key identifier information.

It is to be noted that in the following embodiments, the explanations of the same or corresponding terms and method steps as in the above embodiments may be referred to the above embodiments, which is not repeated here.

FIG. 6 is a schematic flowchart of another method for obtaining a key provided by an embodiment of the present disclosure. The method is performed by a second network device of a home network of a terminal device.

For example, the second network device may be a first AAnF network element hAAnF of the home network of the terminal device, or may be an NEF network element of the home network of the terminal device, which is not limited here.

As shown in FIG. 6, the method may include, but is limited to, the following step.
S601: an application key corresponding to key identifier information is determined, where the application key is provided to a first network device in the visited network based on an identifier of the visited network, related to an application function (AF), of the terminal device.

A second network device of the home network of the terminal device may generate, based on a request (may contain the key identifier information) from the AF, an application key corresponding to the key identifier information, or may receive the application key corresponding to the key identifier information sent by AUSF. For example, the AF requests kakma from the AUSF using the key identifier information sent by the terminal device in a case where the terminal device requests a session service from the application function (AF), the AUSF determines a key management root key (kakma) according to the key identifier information, and sends the key management root key (kakma) to the first AAnF network element, and subsequently, the first AAnF network element may determine the application key according to the key management root key (kakma), which is not limited here.

According to the method for obtaining the key provided by the embodiment of the present disclosure, the first network device includes at least one of a UPF network element, a second AAnF network element, or an access and mobility management function (AMF) network element, which is not limited here.

In the present embodiment, the second network device in the home network of the terminal device determines the application key corresponding to the key identifier information, where the application key is provided to the first network device of the visited network based on the identifier of the visited network, related to the application function (AF), of the terminal device, enabling an AKMA mechanism to effectively support a multiple registrations scenario.

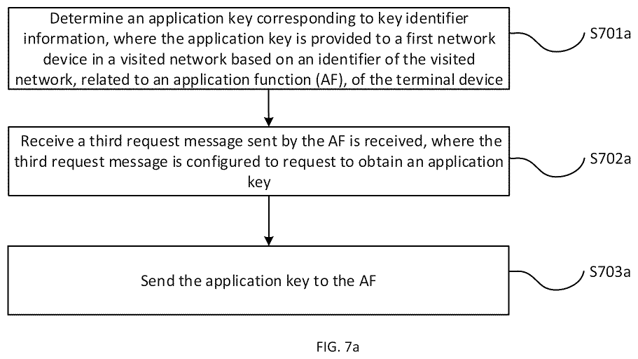

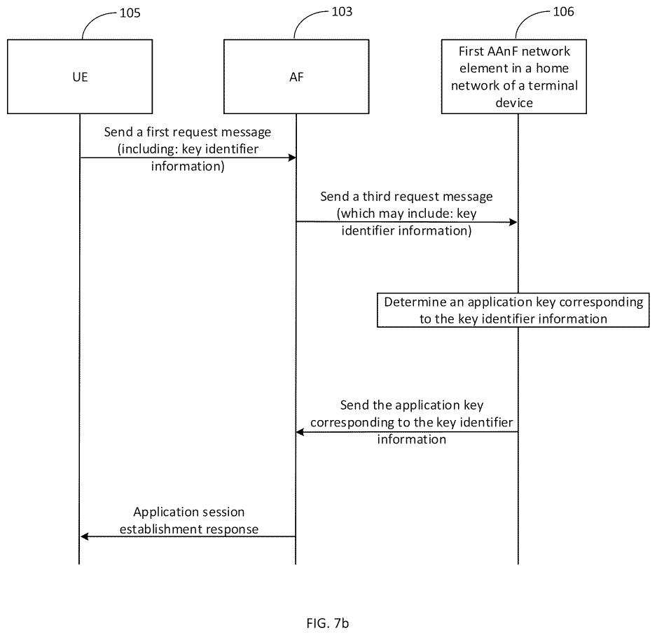

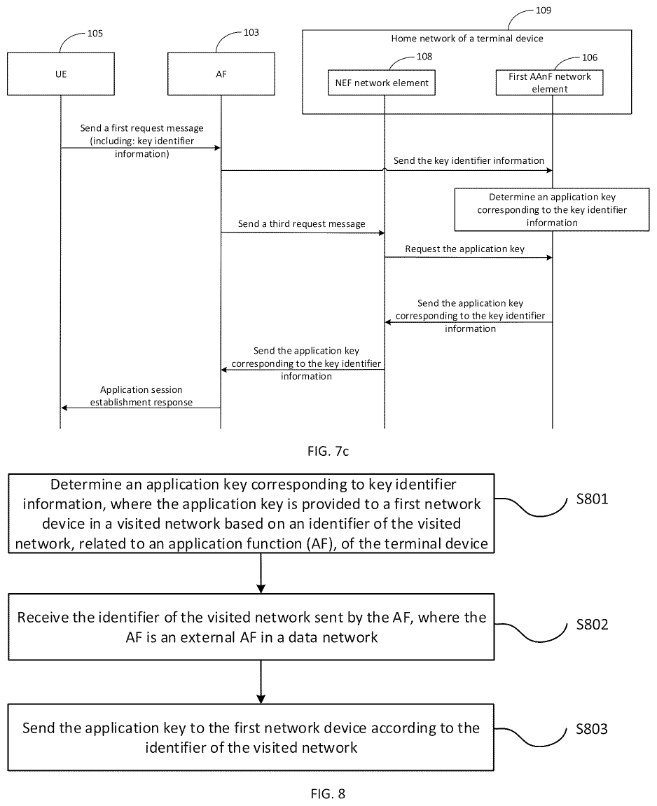

FIG. 7a is a schematic flowchart of another method for obtaining a key provided by an embodiment of the present disclosure. The method is performed by a second network device of a home network of a terminal device. For example, the second network device may be a first AAnF network element hAAnF in the home network of the terminal device, or may be an NEF network element in the home network of the terminal device, which is not limited here.

As shown in FIG. 7a, the method may include, but is not limited to, the following steps.
S701a: an application key corresponding to key identifier information is determined, where the application key is provided to a first network device in a visited network based on an identifier of the visited network, related to an application function (AF), of the terminal device.
S702a: a third request message sent by the AF is received, where the third request message is configured to request to obtain an application key.

The application key may be sent to the AF based on the third request message sent by the AF after determining the application key corresponding to the key identifier information.
S703a: the application key is sent to the AF.

In the present embodiment, the application key corresponding to the key identifier information is determined, where the application key is provided to the first network device in the visited network based on the identifier of the visited network, related to the application function (AF), of the terminal device. The third request message sent by the AF is received, where the third request message is configured to request to obtain the application key. The application key is sent to the AF. This enables the AKMA mechanism to effectively support a multiple registrations scenario and allows for timely establishment of the application session connection between the AF and the UE, effectively improving the efficiency of application session establishment in the multiple registrations scenario.

Timing diagrams for the present embodiment may be shown in FIG. 7b and FIG. 7c. FIG. 7b is a schematic flowchart of another method for obtaining a key provided by an embodiment of the present disclosure. FIG. 7b shows a schematic diagram of interactions among an AF 103, a terminal device (for example, a user equipment (UE) 105) and a first AAnF network element 106 in a second network device. FIG. 7c is a schematic flowchart of another method for obtaining a key provided by an embodiment of the present disclosure. FIG. 7c shows a schematic diagram of interactions among an AF 103, a terminal device (for example, a user equipment (UE) 105), and second network devices (including a first AAnF network element 106 and an NEF network element 108). The first AAnF network element 106 and the NEF network element 108 are in the home network 109 of a terminal device.

In FIG. 7b, the second network device includes: a first AKMA anchor function (AAnF) network element. Receiving the third request message sent by the AF includes: receiving, by the first AAnF network element, the third request message sent by the AF, where the AF is located in the home network. Sending the application key to the AF includes: sending, by the first AAnF network element, the application key to the AF, where the AF is located in the home network.

In FIG. 7c, the second network device includes: a network exposure function (NEF) network element 108 and a first AAnF network element 106. Receiving the third request message sent by the AF includes: receiving, by the NEF network element, the third request message sent by the AF, where the AF is an external AF in a data network, and the third request message is configured to request the NEF network element to obtain the application key from the first AAnF network element. Sending the application key to the AF includes: sending, by the NEF network element, the application key to the AF, where the AF is the external AF in the data network.

In other words, the embodiments of the present disclosure provide two methods for obtaining the application key. The way for obtaining the application key may be determined according to the location of the AF. The application key is obtained from the first AAnF network element in the home network in a case where the AF is located in the home network. The application key is obtained from the first AAnF network element by using the NEF network element in the home network in a case where the AF is the external AF in the data network. This improves the flexibility in obtaining the application key, and increases the probability of successfully obtaining the application key.

FIG. 8 is a schematic flowchart of another method for obtaining a key provided by an embodiment of the present disclosure. The method is performed by a second network device in a home network of a terminal device. For example, the second network device may be a first AAnF network element hAAnF in the home network of the terminal device, or may be an NEF network element in the home network of the terminal device, which is not limited here.

As shown in FIG. 8, the method may include, but is limited to, the following steps.
S801: an application key corresponding to key identifier information is determined, where the application key is provided to a first network device in a visited network based on an identifier of the visited network, related to an application function (AF), of the terminal device.
S802: the identifier of the visited network sent by the AF is received, where the AF is an external AF in a data network.
S803: the application key is sent to the first network device according to the identifier of the visited network.

In other words, in the present embodiment, a way of sending the application key to the first network device in the visited network related to the AF is determined according to the location of the AF. The AF provides the identifier of the visited network to a first AAnF network element in the home network of the terminal device in a case where the AF is the external AF in the data network, and the first AAnF network element sends the application key to the first network device in the visited network related to the AF. This improves the flexibility in sending the key, enabling the first network device in the visited network related to the AF to effectively obtain the application key.

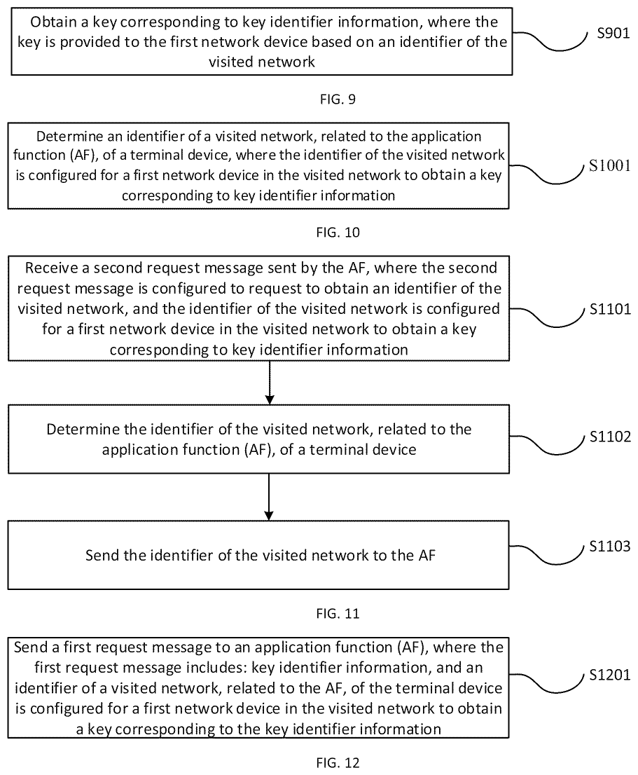

FIG. 9 is a schematic flowchart of another method for obtaining a key provided by an embodiment of the present disclosure. The method is performed by a first network device in a visited network of a terminal device. The visited network is related to an application function (AF).

As shown in FIG. 9, the method may include, but is limited to, the following step.
S901: a key corresponding to key identifier information is obtained, where the key is provided to the first network device based on an identifier of the visited network.

According to the method for obtaining the key provided by the embodiment of the present disclosure, the first network device includes at least one of a UPF network element, a second AAnF network element, or an access and mobility management function (AMF) network element, which is not limited here.

In the present disclosure, the first network device in the visited network, related to the application function (AF), of the terminal device may directly receive an encryption key sent by the AF, where the AF is located in a home network of the terminal device, and the encryption key is derived by the AF from an application key. Alternatively, the first network device may receive an application key sent by a second network device in the home network of the terminal device, where the second network device may be, for example, a first AAnF network element hAAnF in the home network of the terminal device, or may be an NEF network element in the home network of the terminal device. This improves the flexibility in obtaining the key, and increases the probability of successfully obtaining the key.

In the present embodiment, the first network device in the visited network, related to the application function (AF), of the terminal device may obtain the key corresponding to the key identifier information, where the key is provided to the first network device based on the identifier of the visited network, enabling an AKMA mechanism to effectively support a multiple registrations scenario.

FIG. 10 is a schematic flowchart of yet another method for obtaining a key provided by an embodiment of the present disclosure. The method is performed by a first network element. A visited network is related to an application function (AF). The first network element may refer to a function network element in a core network, and the first network element may be at least one of a user plane function (UPF) network element or a policy control function (PCF) network element, which is not limited here.

As shown in FIG. 10, the method may include, but is limited to, the following step.
S1001: an identifier of a visited network, related to the application function (AF), of a terminal device is determined, where the identifier of the visited network is configured for a first network device in the visited network to obtain a key corresponding to key identifier information.

According to the method for obtaining the key provided by the embodiment of the present disclosure, the first network device includes at least one of a UPF network element, a second AAnF network element, or an access and mobility management function (AMF) network element, which is not limited here.

In other words, at least one of the user plane function (UPF) network element or the policy control function (PCF) network element may determine the identifier of the visited network, related to the application function (AF), of the terminal device. This supports at least one of the AF or a second network device in a home network of the terminal device in promptly obtaining the identifier of the visited network, related to the application function (AF), enabling an AKMA mechanism to effectively support a multiple registrations scenario.

FIG. 11 is a schematic flowchart of yet another method for obtaining a key provided by an embodiment of the present disclosure. The method is performed by a first network element. A visited network is related to an application function (AF). The first network element may refer to a function network element in a core network, and the first network element may be at least one of a user plane function (UPF) network element or a policy control function (PCF) network element, which is not limited here.

As shown in FIG. 11, the method may include, but is limited to, the following steps.
S1101: a second request message sent by the AF is received, where the second request message is configured to request to obtain an identifier of the visited network, and the identifier of the visited network is configured for a first network device in the visited network to obtain a key corresponding to key identifier information.
S1102: the identifier of the visited network, related to the application function (AF), of a terminal device is determined.
S1103: the identifier of the visited network is sent to the AF.

According to the method for obtaining the key in the embodiment of the present disclosure, in a case where the first network element is the PCF network element, the AF may take an AF session related to the terminal device UE as a parameter, and subscribe the identifier of the visited network of the terminal device UE to the PCF network element based on the parameter, which is not limited here.

In the present embodiment, at least one of the user plane function (UPF) network element or the policy control function (PCF) network element may receive the second request message sent by the AF, determine, based on the second request message, the identifier of the visited network, related to the application function (AF), of the terminal device, and send the identifier of the visited network to the AF. This supports at least one of the AF or a second network device in a home network of the terminal device in promptly obtaining the identifier of the visited network related to the application function (AF).

FIG. 12 is a schematic flowchart of yet another method for obtaining a key provided by an embodiment of the present disclosure. The method is performed by a terminal device.

As shown in FIG. 12, the method may include, but is limited to, the following step.
S1201: a first request message is sent to an application function (AF), where the first request message includes: key identifier information, and an identifier of a visited network, related to the AF, of the terminal device is configured for a first network device in the visited network to obtain a key corresponding to the key identifier information.

According to the method for obtaining the key provided by the embodiment of the present disclosure, the first network device includes at least one of a UPF network element, a second AAnF network element, or an access and mobility management function (AMF) network element, which is not limited here.

In the present embodiment, the terminal device sends the first request message to the application function (AF), where the first request message includes: the key identifier information. The identifier of the visited network, related to the AF, of the terminal device is configured for the first network device in the visited network to obtain the key corresponding to the key identifier information. This enables an AKMA mechanism to effectively support a multiple registrations scenario.

It is to be noted that the steps of the method for obtaining the key in the above-mentioned embodiment of the present disclosure may be performed at the same time or in any order, which is not limited in the embodiment of the present disclosure.

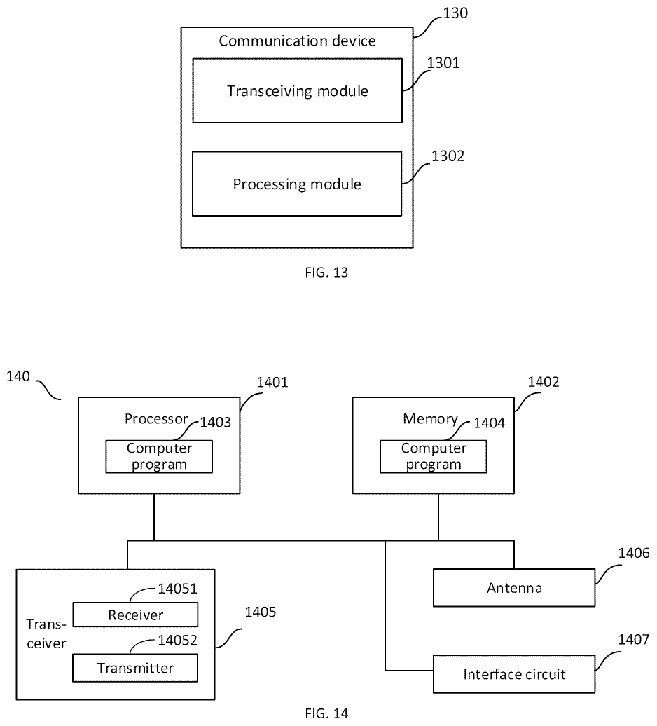

FIG. 13 is a schematic structural diagram of a communication device provided by an embodiment of the present disclosure. The communication device shown in FIG. 13 may include a transceiving module 1301 and a processing module 1302. The transceiving module 1301 may include at least one of a transmitting module or a receiving module. The transmitting module is configured to implement a transmitting function. The receiving module is configured to implement a receiving function. The transceiving module 1301 is able to implement at least one of the transmitting function or the receiving function.

The communication device 130 may be a network device (e.g., the application function (AF), the first network device, the second network device or the first network element in the above method embodiment), or a device in the network device, or a device compatible for use with the network device. Alternatively, the communication device 130 may be a terminal device (e.g., the terminal device in the above method embodiment), or a device in the terminal device, or a device compatible for use with the terminal device.

The communication device 130 is located on a network device side and includes:
a transceiving module 1301, configured to receive a first request message sent by the terminal device, where the first request message includes: key identifier information; or a transceiving module 1301, configured to obtain an application key corresponding to the key identifier information, where the application key is provided to a first network device based on an identifier of a visited network; and
a processing module 1302, configured to determine the identifier of the visited network, related to an AF, of the terminal device, where the identifier of the visited network is configured for a first network device in the visited network to obtain a key corresponding to the key identifier information; or a processing module 1302, configured to determine the key corresponding to the key identifier information, where the key is provided to the first network device in the visited network based on the identifier of the visited network, related to the application function (AF), of the terminal device; or a processing module 1302, configured to determine the identifier of the visited network, related to the application function (AF), of the terminal device, where the identifier of the visited network is configured for the first network device in the visited network to obtain a key corresponding to the key identifier information.

By implementing the method of the present disclosure, the AF receives the first request message sent by the terminal device, where the first request message includes: the key identifier information; and determines the identifier of the visited network, related to the AF, of the terminal device, where the identifier of the visited network is configured for the first network device in the visited network to obtain the key corresponding to the key identifier information. This enables the key corresponding to the key identifier information to be provided merely to the first network device in the visited network related to the AF, without triggering the provision of the key corresponding to key identifier information to network devices in other visited networks unrelated to the AF, enabling an AKMA mechanism to effectively support a multiple registrations scenario.

The communication device 130 is located on a terminal device side and includes: a transceiving module 1301, configured to send the first request message to the application function (AF), where the first request message includes: the key identifier information.

The identifier of the visited network, related to the AF, of the terminal device is configured for the first network device in the visited network to obtain a key corresponding to the key identifier information.

By implementing the method of the present disclosure, the terminal device sends the first request message to the application function (AF), where the first request message includes: the key identifier information. The identifier of the visited network, related to the AF, of the terminal device is configured for the first network device in the visited network to obtain the key corresponding to the key identifier information. This enables the AKMA mechanism to effectively support the multiple registrations scenario.

FIG. 14 is a schematic structural diagram of another communication device provided by an embodiment of the present disclosure. The communication device 140 may be a terminal device (e.g., the terminal device in the above method embodiment), or a network device (e.g., the application function (AF), the first network device, the second network device or the first network element in the above method embodiment) or a chip, a chip system, or a processor, etc., that supports the terminal device in implementing the above methods, or a chip, a chip system, or a processor, etc., that supports the network device in implementing the above methods. The device may be configured to implement the methods described in the above method embodiments, and details may refer to the description in the above method embodiments.

The communication device 140 may include one or more processors 1401. The processor 1401 may be a general-purpose processor or a dedicated processor, etc. For example, the processor may be a baseband processor or a central processor. The baseband processor may be configured to process a communication protocol and communication data. The central processor may be configured to control the communication device (e.g., a base station, a baseband chip, a terminal device, a terminal device chip, DU or CU), execute a computer program and process data associated with the computer program.

Optionally, the communication device 140 may also include one or more memories 1402 storing a computer program 1404. The processor 1401 may store a computer program 1403. The processor 1401 executes at least one of the computer program 1404 or the computer program 1403, enabling the communication device 140 to perform the methods described in the above method embodiments.

Optionally, the memory 1402 may also store data. The communication device 140 and the memory 1402 may be arranged separately or integrated together.

Optionally, the communication device 140 may further include a transceiver 1405 and an antenna 1406. The transceiver 1405 may be referred to as a transceiving unit, a transceiving machine, or a transceiving circuit, etc., configured to implement a transceiving function. The transceiver 1405 may include a receiver 14051 and a transmitter 14052. The receiver 14051 may be referred to as a receiving machine or a receiving circuit, etc., configured to implement a receiving function. The transmitter 14052 may be referred to as a transmitting machine or a transmitting circuit, etc., configured to implement a transmitting function.

Optionally, the communication device 140 may further include one or more interface circuits 1407. The interface circuit 1407 is configured to receive and transmit code instructions to the processor 1401. The processor 1401 runs the code instructions, enabling the communication device 140 to perform the methods described in the above method embodiments.

In one implementation, the processor 1401 may include a transceiver configured to implement both a receiving function and a transmitting function. For example, the transceiver may be a transceiving circuit, or an interface, or an interface circuit. The transceiving circuit, the interface or the interface circuit, configured to implement both the receiving function and the transmitting function, may be arranged separately or integrated together. The transceiving circuit, the interface or the interface circuit may be configured to read and write codes/data, or transmit or transfer a signal.

In one implementation, the processor 1401 may store a computer program 1403. The computer program 1403 runs on the processor 1401, enabling the communication device 140 to perform the methods described in the above method embodiments. The computer program 1403 may be solidified in the processor 1401. In this case, the processor 1401 may be implemented in hardware.

In one implementation, the communication device 140 may include a circuit. The circuit may be able to implement a transmitting or receiving or communicating function described in the above method embodiments. The processor and the transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and the transceiver may be fabricated using a variety of IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe) or gallium arsenide (GaAs).

The communication device described in the above embodiment may be a terminal device (e.g., the terminal device in the above method embodiment) or a network device (e.g., the application function (AF), the first network device, the second network device and the first network element in the above method embodiment). However, the scope of the communication device described in the present disclosure is not limited to these examples, and the structure of the communication device is not limited by FIG. 14. The communication device may be a stand-alone device or part of a larger device. For example, the communication device may be:
(1) a stand-alone integrated circuit IC, or chip, a chip system or a subsystem;
(2) a set with one or more ICs, and optionally, the IC set may also include a storage part for storing data and computer programs;
(3) ASIC, such as a modem;
(4) a module that may be embedded in other devices;
(5) a receiver, a terminal device, an intelligent terminal device, a cellular phone, a wireless device, a handset, a mobile unit, a vehicular device, a network device, a cloud device, an artificial intelligence device, etc.; and
(6) others.

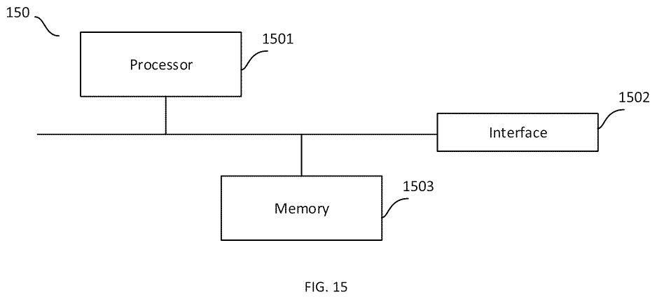

In a case where the communication device be a chip or a chip system, referring to FIG. 15, FIG. 15 is a schematic structural diagram of a chip provided by an embodiment of the present disclosure. The chip shown in FIG. 15 includes a processor 1501 and an interface 1502. One or more processors 1501 may be provided, and one or more interfaces 1502 may be provided.

In a case where the chip is configured to implement the functions of the network device in the embodiment of the present disclosure:
the processor 1501 is configured to implement the steps of the methods in the embodiments shown in FIGS. 2 to 11.

In a case where the chip is configured to implement the functions of the terminal device in the embodiment of the present disclosure:
the processor 1501 is configured to implement the steps of the method in the embodiment shown in FIG. 12.

Optionally, the chip further includes a memory 1503. The memory 1503 is configured to store needed computer programs and data.

As used herein, the term processor may refer to one processor that performs the defined functions or a plurality of processors that collectively perform defined functions, such that the execution of the individual defined functions may be divided amongst such processors.

A person skilled in the art may understand that various illustrative logical blocks and steps listed in the embodiments of the present disclosure may be implemented in electronic hardware, computer software, or a combination of both. Whether these functions are implemented in hardware or software depends on specific applications and design requirements of the entire system. A person skilled in the art may use various methods for each particular application to implement the described functions. However, such implementation could not be construed as exceeding the protection scope of the embodiments of the present disclosure.

An embodiment of the present disclosure further provides a communication system. The system includes a communication device serving as a network device (e.g., the application function (AF), the first network device, the second network device and the first network element in the above method embodiment) and a communication device serving as a terminal device in the embodiment shown in FIG. 13; or the system includes a communication device serving as a network device (e.g., the application function (AF), the first network device, the second network device and the first network element in the above method embodiment) and a communication device serving as a terminal device in the embodiment shown in FIG. 14.

The present disclosure further provides a non-transitory computer-readable storage medium storing instructions, where the instructions, when executed by a computer, enables to implement the functions in any of the above method embodiments.

The present disclosure further provides a computer program product. The computer program product, when executed by a computer, implements the functions in any of the above methods.

In the above embodiments, the functions may be entirely or partially implemented in software, hardware, firmware or any combination of these. The functions may be entirely or partially implemented in the form of a computer program product in a case of being implemented in software, where the computer program product includes one or more computer programs. The flows or functions described in the embodiments of the present disclosure are generated entirely or partially in a case where the computer program is loaded onto and executed by a computer. The computer may be a general-purpose computer, a dedicated computer, a computer network, or other programmable devices. The computer program may be stored on a computer-readable storage medium, or transmitted from one computer-readable storage medium to another computer-readable storage medium. For example, the computer program may be transmitted from one website site, a computer, a server or a data center to another website site, computer, server or data center via a wired mean (such as a coaxial cable, an optical fiber, or a digital subscriber line (DSL)) or wireless mean (such as infrared, wireless, or microwave). The computer-readable storage medium may be any available medium that may be accessed by the computer or a data storage device such as a server or a data center containing one or more available mediums. The available medium may be a magnetic medium (e.g., a floppy disk, a hard disk or a magnetic tape), an optical medium (e.g., a high-density digital video disc (DVD)), or a semiconductor medium (e.g., a solid state disk (SSD)).

A person of ordinary skill in the art may understand that “first,” “second” and other numerical symbols involved in the present disclosure are merely for distinguishing elements for convenience and indicate a particular order, rather than limiting the scope of the embodiments of the present disclosure.

The expression “at least one” as used in the present disclosure may be described as “one or more”, where “more” may refer to two, three, four, or more, which is not limited in the present disclosure. In the embodiments of the present disclosure, the technical features are distinguished by the terms “first,” “second,” “third,” “A,” “B,” “C” or “D” in a case of describing a certain technical feature. The technical features described by “first,” “second,” “third,” “A,” “B,” “C” or “D” have no sequential or hierarchical order.

In the present disclosure, the corresponding relationships shown in the tables may be either configured or predefined. The values of the information in each table are merely examples and may be configured to other values, which is not limited in the present disclosure. Configuring all the corresponding relationships shown in the tables is not needed in a case of configuring the corresponding relationships between the information and various parameters. For example, in the tables in the present disclosure, the corresponding relationships shown in certain rows may not be configured. For example, the tables may be appropriately modified, such as by splitting and merging. The names of the parameters indicated in the headings of the above tables may be expressed using other names understandable by the communication device, and the values or representations of the parameters may be expressed using other values or representations understandable by the communication device. In implementation, the tables may also adopt other data structures, such as arrays, queues, containers, stacks, linear tables, pointers, linked lists, trees, graphs, structs, classes, heaps, hash tables, or other appropriate formats.

The terms “predefined” as used in the present disclosure may be understood as defining, pre-defining, storing, pre-storing, pre-negotiation, pre-configuration, solidification, or pre-firing.

A person of ordinary skill in the art may recognize that the units and algorithm steps described in combination with various examples described in the disclosed embodiments may be implemented in electronic hardware, computer software, or a combination of both. Whether these functions are implemented in hardware or software depends on the particular application and design constraints of the technical solutions. A person skilled in the art may achieve the described functions by using different methods for each particular application. However, such implementation could not be construed as exceeding the scope of the present disclosure.

A person skilled in the art may clearly understand that, for the convenience and clarity of the description, the specific working process of the system, device and units as described above may refer to the corresponding process in the foregoing method embodiments, which is not repeated here.

The above are merely specific embodiments of the present disclosure, and are not to limit the protection scope of the present disclosure. Within the technical scope disclosed in the present disclosure, any modifications or replacements that are easily conceived by a person skilled in the art are to fall within the protection scope of the present disclosure. Accordingly, the protection scope of the present disclosure is determined by the protection scope of the appended claims.

1. A method for obtaining a key, performed by an application function (AF), wherein the method comprises:
receiving a first request message sent by a terminal device, wherein the first request message comprises key identifier information; and
determining an identifier of a visited network, related to the AF, of the terminal device, wherein the identifier of the visited network is configured for a first network device in the visited network to obtain a key corresponding to the key identifier information.

2. The method according to claim 1, wherein determining the identifier of the visited network, related to the AF, of the terminal device comprises:
sending a second request message to a first network element, wherein the second request message is configured to request to obtain the identifier of the visited network; and
receiving the identifier of the visited network sent by the first network element.

3. The method according to claim 1, wherein determining the identifier of the visited network, related to the AF, of the terminal device comprises:
obtaining the identifier of the visited network, related to the AF, from a local policy of the AF, wherein the local policy of the AF is a local policy associated with a first network element involved in establishing service connections with the terminal device.

4. The method according to claim 1, wherein the method further comprises:
sending a third request message to a second network device in a home network of the terminal device, wherein the third request message is configured to request to obtain an application key; and
receiving the application key sent by the second network device.

5. The method according to claim 4, wherein the second network device comprises a first authentication and key management for application (AKMA) anchor function (AAnF) network element;
wherein sending the third request message to the second network device in the home network of the terminal device comprises:
sending the third request message to the first AAnF network element in a case where the AF is located in the home network; and
receiving the application key sent by the second network device comprises:
receiving the application key sent by the first AAnF network element.

6. The method according to claim 4, wherein the second network device comprises a network exposure function (NEF) network element and a first AAnF network element;
wherein sending the third request message to the second network device in the home network of the terminal device comprises:
sending the third request message to the NEF network element in a case where the AF is an external AF in a data network, wherein the third request message is configured to request the NEF network element to obtain the application key from the first AAnF network element; and
receiving the application key sent by the second network device comprises:
receiving the application key sent by the NEF network element.

7. The method according to claim 1, wherein the method further comprises:
deriving an encryption key according to an application key in a case where the AF is located in a home network of the terminal device; and
sending the encryption key to the first network device in the visited network according to the identifier of the visited network.

8. The method according to claim 4, wherein the second network device in the home network of the terminal device comprises a first AAnF network element; and the method further comprises:
sending the identifier of the visited network to the first AAnF network element in a case where the AF is an external AF in a data network.

9-10. (canceled)

11. A method for obtaining a key, performed by a second network device in a home network of a terminal device, wherein the method comprises:
determining an application key corresponding to key identifier information, wherein
the application key is provided to a first network device in a visited network based on an identifier of the visited network, related to an application function (AF), of the terminal device.

12. The method according to claim 11, further comprising:
receiving a third request message sent by the AF, wherein the third request message is configured to request to obtain the application key; and
sending the application key to the AF.

13. The method according to claim 12, wherein the second network device comprises a first authentication and key management for application (AKMA) anchor function (AAnF) network element;
wherein receiving the third request message sent by the AF comprises:
receiving, by the first AAnF network element, the third request message sent by the AF, wherein the AF is located in the home network; and
sending the application key to the AF comprises:
sending, by the first AAnF network element, the application key to the AF, wherein the AF is located in the home network.

14. The method according to claim 12, wherein
the second network device comprises a network exposure function (NEF) network element and a first AAnF network element;
receiving the third request message sent by the AF comprises:
receiving, by the NEF network element, the third request message sent by the AF, wherein the AF is an external AF in a data network, and the third request message is configured to request the NEF network element to obtain the application key from the first AAnF network element; and
sending the application key to the AF comprises:
sending, by the NEF network element, the application key to the AF, wherein the AF is the external AF in the data network.

15. The method according to claim 11, wherein the method further comprises:
receiving the identifier of the visited network sent by the AF, wherein the AF is an external AF in a data network; and
sending the application key to the first network device according to the identifier of the visited network.

16. (canceled)

17. A method for obtaining a key, performed by a first network device in a visited network of a terminal device, wherein the visited network is related to an application function (AF); and the method comprises:
obtaining a key corresponding to key identifier information, wherein the key is provided to the first network device based on an identifier of the visited network.

18. The method according to claim 17, wherein obtaining the key corresponding to the key identifier information comprises:
receiving an encryption key sent by the AF, wherein the AF is located in a home network of the terminal device.

19. The method according to claim 17, wherein obtaining the key corresponding to the key identifier information comprises:
receiving an application key sent by a second network device in the home network of the terminal device, wherein the AF is an external AF in a data network.

20-33. (canceled)

34. A non-transitory computer-readable storage medium storing instructions, wherein the instructions, when executed by one or more processors, cause the one or more processors to collectively perform the method according to claim 1.

35. A communication device, comprising:
one or more processors; and
a memory that stores a computer program,
wherein the one or more processors are collectively configured to execute the computer program stored in the memory to cause the communication device to perform the method according to claim 1.

36. A communication device, comprising:
one or more processors; and
a memory that stores a computer program,
wherein the one or more processors are collectively configured to execute the computer program stored in the memory to cause the communication device to perform the method according to claim 11.

37. A communication device, comprising:
one or more processors; and
a memory that stores a computer program,
wherein the one or more processors are collectively configured to execute the computer program stored in the memory to cause the communication device to perform the method according to claim 17.
